(19) United States
(12) Patent Application Publication
(10) Pub. No.: US 2004/0146287 A1
(43) Pub. Date: Jul. 29, 2004

(54) Method of adjusting screen display properties using video pattern, DVD player providing video pattern, and method of providing information usable to adjust a display characteristic of a dispaly

(75) Inventor: Hyoung-Woo Jeon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/716,421

(22) Filed: Nov. 20, 2003

(30) Foreign Application Priority Data
Jan. 7, 2003 (KR) 2003-775

(51) Int. Cl. H04N 5/781

(52) U.S. Cl. 386/125; 386/126

(57) ABSTRACT

A method of adjusting a display, which is connected to a DVD player, according to image signals provided by the DVD player. The method includes: accessing one of one or more video patterns stored in a memory of the DVD player; displaying the accessed video pattern on the display; and adjusting the display while checking the displayed video pattern which provides the user with information regarding the adjustment.

### CROSS-REFERENCE TO RELATED APPLICATIONS

This application claims the benefit of Korean Application No. 2003-775, filed Jan. 7, 2003, in the Korean Intellectual Property Office, the disclosure of which is incorporated herein by reference.

### BACKGROUND OF THE INVENTION

1. Field of the Invention

The present invention relates to a screen adjustment method and a digital versatile disc (DVD) player, and more particularly, to a method of adjusting display properties of a display using video patterns stored in the memory of a DVD player, a DVD player providing the video patterns, and a method of providing information to adjust a display characteristic.

2. Description of the Related Art

Recently, there has been an increase in the number of users who watch movies through a digital versatile disc (DVD) player connected to a TV. As used herein, the term TV means a display device such as a television or a monitor. When users watch movies reproduced by the DVD player, the TV screen may be unclear (i.e., the images displayed on the screen may not be sharp or may be improperly tinted). This view may contrast with what was previously observed in an advertisement or TV screen shown at an electronic appliance shop and may be undesirable. In this case, users have to adjust the luminance, color, and sharpness of the TV screen according to their preference.

Movies reproduced by the DVD player consist of continuously changing pictures and are not capable of providing users with a reference suitable for TV screen adjustment. In other words, TV screen adjustment varies with the movie currently reproduced. Thus, users must adjust the TV screen for each separate movie.

Although standard image signals are output to the TV connected to the DVD player, the screen display will still be poor if the TV screen is distorted (i.e., the display properties of the TV require adjustment). In other words, even when the DVD player outputs standard image signals to the connected TV, it is necessary for users to separately adjust the TV screen.

### SUMMARY OF THE INVENTION

The present invention provides a method of adjusting a TV screen, by which a user can adjust the luminance, color, and sharpness of the TV screen while checking the displayed video patterns stored in the flash memory of a DVD player.

The present invention also provides a DVD player which stores and provides video patterns for a user to adjust the luminance, color, and sharpness of a TV screen.

Additional aspects and/or advantages of the invention will be set forth in part in the description which follows and, in part, will be obvious from the description, or may be learned by practice of the invention.

According to an aspect of the present invention, there is provided a method of adjusting a display of a display device, which is connected to a DVD player, according to image signals provided by the DVD player. The method includes accessing one of one or more video patterns in a memory of the DVD player, displaying the accessed video pattern on the display, and adjusting the display while checking the displayed video pattern. The displayed video pattern provides the user with information regarding the adjustment.

According to another aspect of the present invention, there is provided a DVD player connectable to a display device. The DVD player includes a memory, a control unit, and an output unit. The memory stores at least one video pattern. The control unit controls selection of a video pattern stored in the memory. The output unit outputs a selected video pattern to the display device. The selected video pattern is displayed on a display of the display device and provides the user with information with which the user can adjust the display while checking a displayed video pattern.

The memory of the DVD player may be a flash memory.

The video pattern may be a set of color bars that are test image signals, which are used to adjust luminance and color delay of the display device.

The video pattern may be a test pattern that is a still screen, which is used to evaluate overall screen quality, so that the user can adjust position and/or sharpness of the display device.

The video pattern may represent 10 ascending levels of luminance, which is expressed by dividing luminance of a TV screen by 10 and is usable to adjust contrast and/or brightness of the display device.

According to another aspect of the present invention, there is provided a method of adjusting a display property of a display connected to a DVD player, including: selecting one of one or more video test patterns stored in a memory of the DVD player; accessing the selected test pattern; displaying the selected video test pattern on the display; and adjusting the display property of the display while observing an effect of the adjustment on the display of the selected video test pattern.

According to yet another aspect of the present invention, there is provided a method of providing information usable to adjust a display property of an adjustable display, including: storing one or more video test patterns in a memory of a DVD player; providing an inputter which allows a user to input a video test pattern selection; providing an outputter which outputs a selected video test pattern to an adjustable display. An adjustment to a display property of the adjustable display is observable by an effect thereof on a presentation of the selected video test pattern by the adjustable display.

According to yet another aspect of the present invention, there is provided a DVD player including: a memory storing one or more video test patterns; a control unit which controls selection of the one or more video test patterns; and an output unit which outputs a selected video test pattern to an adjustable display. An adjustment to a display property of the adjustable display is observable by an effect thereof on a display of the selected video test pattern by the adjustable display.

According to yet another embodiment, there is provided A method of adjusting a display property of a display, including: displaying a pattern provided by a DVD player; and adjusting one of a luminance, color delay, position, sharpness, contrast, and brightness in accordance with an effect of the adjusting on the display of the pattern.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 schematically illustrates a DVD player providing video patterns and a TV receiving the video patterns from the DVD player according to an embodiment of the present invention;

FIG. 2 is a flowchart illustrating a method of adjusting a TV screen using a video, according to an embodiment of the present invention;

FIG. 3 illustrates a set of color bars which may constitute the video pattern user in the method of FIG. 2;

FIG. 4 illustrates a test pattern which may constitute the video pattern user in the method of FIG. 2;

FIG. 5 illustrates 10 ascending levels of luminance which may constitute the video pattern user in the method of FIG. 2; and

FIG. 6 is a flowchart illustrating a method of TV screen adjustment using video patterns according to an embodiment of the present invention.

### DETAILED DESCRIPTION OF A PREFERRED EMBODIMENT

Reference will now be made in detail to an embodiment of the present invention, an example of which is illustrated in the accompanying drawings, wherein like reference numerals refer to the like elements throughout. The embodiment is described below in order to explain the present invention by referring to the figures.

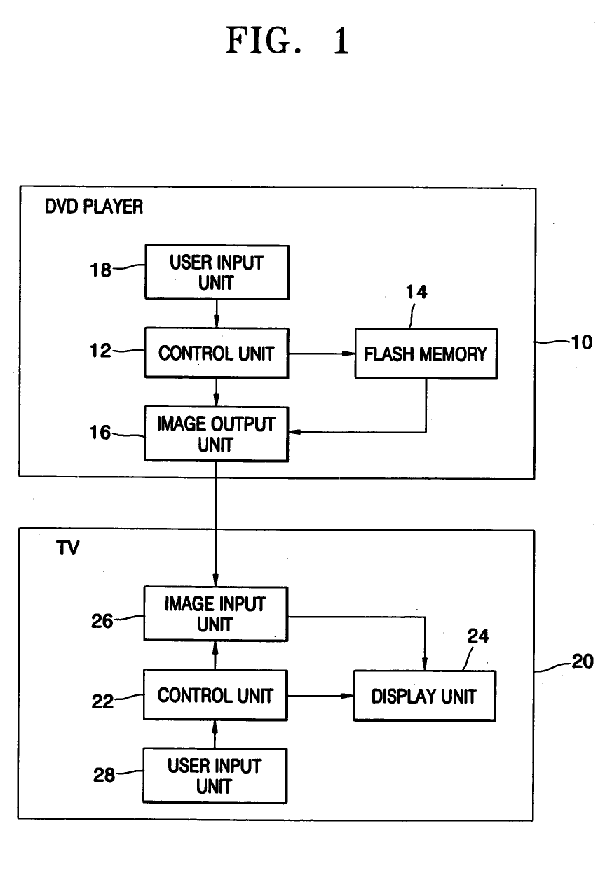

FIG. 1 schematically illustrates a DVD player providing video patterns and a TV receiving the video patterns from the DVD player. While the following discussion identifies a TV as a display, it is to be understood that other displays are possible. Since the present invention relates to screen adjustment, the following description will focus on aspects of imaging.

Referring to FIG. 1, a DVD player 10 includes a control unit 12, a flash memory 14, an image output unit 16, and a user input unit 18. A TV 20 connected to the DVD player 10 includes a control unit 22, a display unit 24, an image input unit 26, and a user input unit 28. A TV screen (not shown) is adjusted according to image signals provided by the DVD player 10. The flash memory 14 of DVD player 10 stores at least one video pattern. The control unit 12 of DVD player 10 controls the selection of a video pattern from the flash memory 14. While a flash memory is illustrated and described, it is to be understood that other forms of memory are possible. The selected video pattern is then displayed on the TV screen. The image output unit 16 of the DVD player 10 outputs the selected video pattern to the TV 20. The image input unit 26 of TV 20 receives the video pattern output from the image output unit 16 of DVD player 10. Under the control of the control unit 22 of TV 20, the display unit 24 displays the input video pattern on the TV screen. A user adjusts the TV screen using the user input unit 28 of TV 20 while checking the displayed video pattern. The user input unit 18 of DVD player 10 or the user input unit 28 of TV 20 may be used by the user to select a video pattern from the flash memory 14 of DVD player 10.

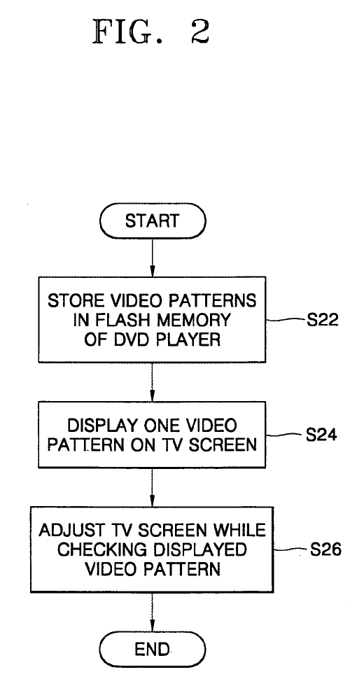

FIG. 2 is a flowchart illustrating a method of adjusting the TV screen using a video pattern, according to the present embodiment of the present invention.

Referring to FIG. 2, in the first operation S22, at least one stored video pattern is in the flash memory 14 (shown in FIG. 1) of the DVD player 10 (shown in FIG. 1). In the next operation S24, the display unit displays a video pattern accessed from the flash memory on the TV screen of TV 20 (shown in FIG. 1). Then, in operation S26, the user adjusts the TV screen while checking the displayed video pattern.

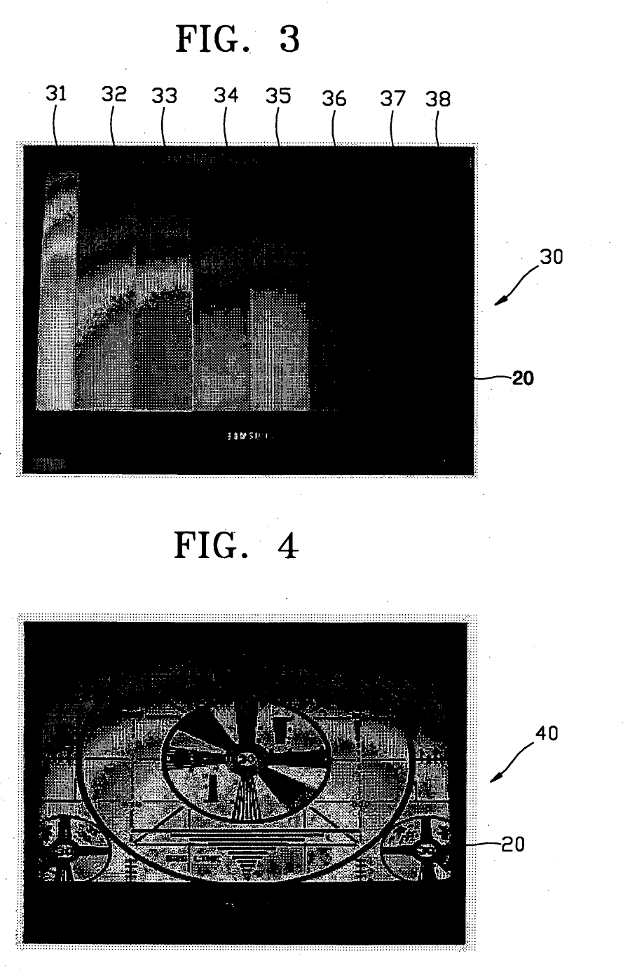

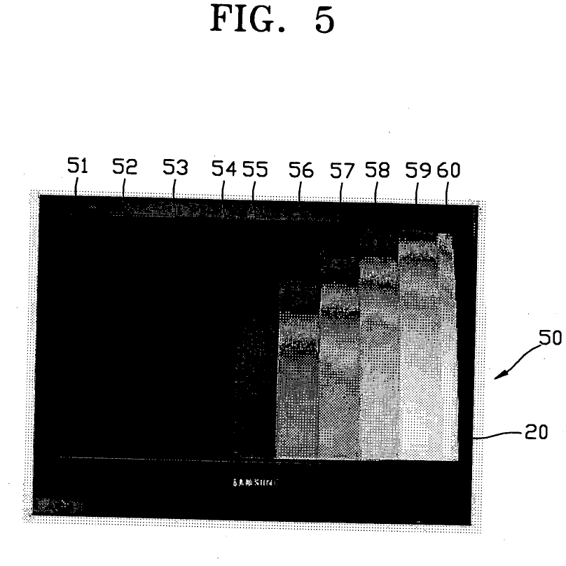

Hereinafter, video patterns used for TV screen adjustment will be described with reference to FIGS. 1 and 3 through 5. FIG. 3 illustrates a set of color bars 30 displayed on a TV screen of TV 20. The set of color bars 30 represents test image signals for adjusting the luminance and color delay of a TV screen. FIG. 4 illustrates a test pattern 40 displayed on the TV screen of TV 20. The test pattern 40 is a still screen and is used to evaluate overall screen quality, so that the user can adjust position and/or sharpness of TV screen. FIG. 5 illustrates 10 ascending levels of luminance 50 displayed on the TV screen of TV 20. The 10 ascending levels of luminance 50 are expressed by dividing the luminance of the TV screen into 10 steps or levels. The 10 ascending levels of luminance 50 is used to adjust contrast and/or luminance of a TV screen of TV 20. While three test patterns are described below and illustrated herein, it is to be understood that other test patterns are possible.

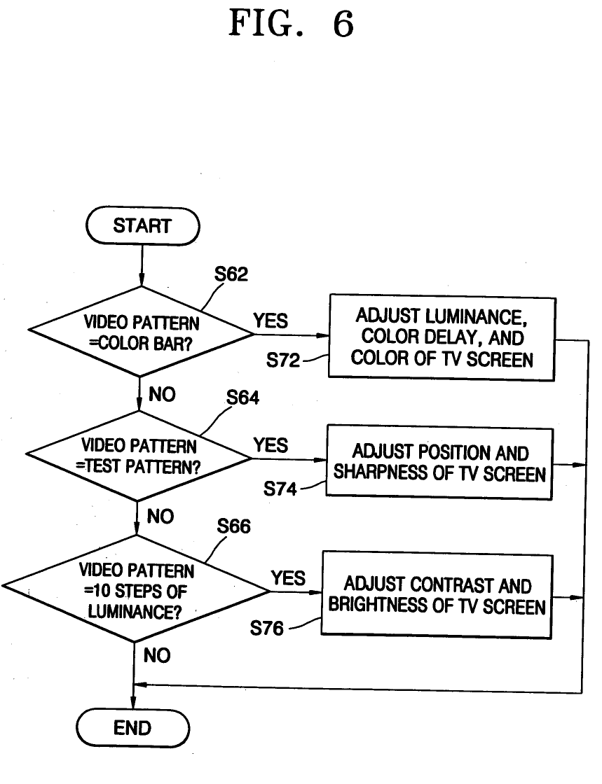

FIG. 6 is a flowchart describing TV screen adjustment using video patterns.

Hereinafter, TV screen adjustment will be described with reference to FIGS. 3 through 6. According to the present embodiment of the present invention, users can adjust the TV screen using the quality adjustment menu of a DVD player or a TV, as desired. In other words, a user can adjust various display properties of the TV while observing the effects of the adjustments on the display of the test pattern. It is assumed that the DVD player includes a menu that allows the user to select the video pattern.

When the user selects the set of color bars to adjust the TV screen in operation S62, the user can adjust the luminance, color delay, and color of the TV screen in operation S72. Referring to FIG. 3, the set of color bars 30 includes 8 vertical color bars indicating luminance and color. In order from left to right, a white bar 31, a yellow bar 32, a cyan bar 33, a green bar 34, a magenta bar 35, a red bar 36, a blue bar 37, and a black bar 38 are included in the set of color bars 30. The set of color bars 30 is used to determine the luminance and color delay, and to check if all colors are displayed well. In other words, the user checks the set of color bars 30, recognizes the luminance and color delay, and then adjusts the screen for the optimal screen quality. If the luminance and color are seriously distorted, screen dimming occurs. Yet, if the user adjusts the luminance and color delay, the screen display is improved. In addition, the user can check if all colors are displayed well using the set of color bars, thereby providing a basis for adjusting the color of the TV screen.

When the user selects the test pattern to adjust the TV screen in operation S64, the user can adjust the position and sharpness of the TV screen in operation S74. Referring to FIG. 4, the test pattern 40 includes a circle at the center, multiple stripes, and multiple figures, indicating the level of luminance. The test pattern 40 is used to adjust the position and sharpness of the TV screen. Numbers are shown at the four sides of the test pattern. While checking the test pattern, the user can recognize the direction in which the screen bends and adjust the TV screen, so that images can be disposed at the center of the TV screen. In addition, while checking the test pattern, the user can check and adjust the sharpness of the TV screen.

When the user selects the 10 ascending levels of luminance in operation S66, the user can adjust the contrast and luminance of the TV screen in operation S76. Referring to FIG. 5, the 10 ascending levels of luminance 50 are expressed by dividing the luminance of the TV screen into 10 steps. The 10 ascending levels of luminance are used to adjust the contrast and brightness of the TV screen. Since the luminance of the TV screen is divided into 10 ascending levels, ranging from the brightest spot to the darkest spot, the user can adjust the contrast and brightness of the TV screen to avoid saturation in each ascending levels.

The number of video patterns is limited by the capacity of the flash memory of the DVD player. Hence, many video patterns can be provided depending on the capacity of the flash memory, and video patterns different from those of the present invention can also be provided.

As described above, the user can adjust the TV screen using video patterns from the DVD player. In other words, the user can adjust the luminance, color delay, position, sharpness, contrast, and brightness of a TV screen, using video patterns provided by the DVD player.

Although a few embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined by the claims and their equivalents.

What is claimed is:

1. A method of adjusting a display of a display device, which is connected to a DVD player, according to image signals provided by the DVD player, comprising:
accessing one of one or more video patterns stored in a memory of the DVD player;
displaying the accessed video pattern on the display; and
adjusting the display while checking the displayed video pattern which provides the user with information regarding the adjustment.

2. The method of claim 1, wherein the memory of the DVD player comprises a flash memory.

3. The method of claim 1, wherein the video pattern is a set of color bars which are test image signals usable to adjust a luminance and a color delay of the display.

4. The method of claim 1, wherein the video pattern is a test pattern which is a still screen usable to evaluate overall screen quality, so that the user can adjust at least one of a position and a sharpness of the display.

5. The method of claim 1, wherein the video pattern is 10 levels of luminance, which is expressed by dividing luminance of the display by 10 and is usable to adjust at least one of a contrast and a brightness of the display.

6. The method of claim 2, wherein the video pattern is a set of color bars which are test image signals, which are used to adjust a luminance and a color delay of the display.

7. The method of claim 2, wherein the video pattern is a test pattern which is a still screen usable to evaluate an overall screen quality, so that the user can adjust at least one of a position and sharpness of the display.

8. The method of claim 2, wherein the video pattern is 10 levels of luminance, which is expressed by dividing a luminance of the display by 10 and is usable to adjust at least one of a contrast and a brightness of the display.

9. The method of claim 1, wherein the display is one of a TV screen of a TV and a screen of a monitor.

10. A DVD player connectable to an image display device, comprising:
a memory which stores at least one video pattern;
a control unit which controls selection of a video pattern stored in the memory; and
an output unit which outputs a selected video pattern to the image display device, wherein the selected video pattern is displayed on a display of the image display device and provides the user with information with which the user can adjust the display while checking a displayed video pattern.

11. The DVD player of claim 10, wherein the memory of the DVD player comprises a flash memory.

12. The method of claim 10, wherein the video pattern is a set of color bars which are test image signals usable to adjust a luminance and a color delay of the display.

13. The method of claim 10, wherein the video pattern is a test pattern which is a still screen usable to evaluate overall screen quality, so that the user can adjust at least one of a position and a sharpness of the display.

14. The method of claim 10, wherein the video pattern is 10 levels of luminance, which is expressed by dividing luminance of the display by 10 and is usable to adjust at least one of a contrast and a brightness of the display.

15. The method of claim 11, wherein the video pattern represents color bars which are test image signals, which are used to adjust luminance and color delay of the display.

16. The method of claim 11, wherein the video pattern is a test pattern which is a still screen usable to evaluate overall screen quality, so as to enable the user to adjust at least one of a position and a sharpness of the display.

17. The method of claim 11, wherein the video pattern is 10 steps of luminance, which is expressed by dividing a luminance of the display by 10 steps and is usable to adjust at least one of contrast and a brightness of the display.

18. The method of claim 10, wherein the display is one of a TV screen of a TV and a screen of a monitor.

19. A method of adjusting a display property of a display connected to a DVD player, comprising:
selecting one of one or more video test patterns stored in a memory of the DVD player;
accessing the selected test pattern;
displaying the selected video test pattern on the display; and
adjusting the display property of the display while observing an effect of the adjustment on the display of the selected video test pattern.

20. The method of claim 19, wherein the selecting comprises accessing a menu of the DVD player which allows a user to select one of the one or more video test patterns.

21. The method of claim 19, wherein the memory is a flash memory.

22. The method of claim 19, wherein the one or more video test patterns are one of a set of color bars, a still screen having geometric patterns thereon, and a set of luminance bars of various luminance.

23. A method of providing information usable to adjust a display property of an adjustable display, comprising:
storing one or more video test patterns in a memory of a DVD player;
providing an inputter which allows a user to input a video test pattern selection;
providing an outputter which outputs a selected video test pattern to an adjustable display,
wherein an adjustment to a display property of the adjustable display is observable by an effect thereof on a presentation of the selected video test pattern by the adjustable display.

24. A DVD player comprising:
a memory storing one or more video test patterns;
a control unit which controls selection of the one or more video test patterns; and
an output unit which outputs a selected video test pattern to an adjustable display, wherein an adjustment to a display property of the adjustable display is observable by an effect thereof on a display of the selected video test pattern by the adjustable display.

25. A method of adjusting a display property of a display, comprising:
displaying a pattern provided by a DVD player; and
adjusting one of a luminance, color delay, position, sharpness, contrast, and brightness in accordance with an effect of the adjusting on the display of the pattern.

26. The method of claim 25, wherein the pattern is a set of color bars which are test image signals usable to adjust the luminance and the color delay of the display.

27. The method of claim 25, wherein the pattern is a still screen usable to evaluate overall screen quality, so that the user can adjust at least one of the position and the sharpness of the display.

28. The method of claim 25, wherein the pattern is 10 levels of luminance, which is expressed by dividing luminance of the display by 10 and is usable to adjust at least one of the contrast and the brightness of the display.
